(19) United States
(12) Patent Application Publication
(10) Pub. No.: US 2010/0084089 A1
(43) Pub. Date: Apr. 8, 2010

(54) METHOD OF FUSING THERMOPLASTIC COMPONENTS

(76) Inventor: Christopher Simon Courtenay Wheaton, Devonshire (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/593,349

(22) PCT Filed: Mar. 27, 2008
(86) PCT No.: PCT/GB08/01054

§ 371 Date: Dec. 11, 2009

(30) Foreign Application Priority Data
Mar. 28, 2007 (GB) 0705946.2

(51) Int. Cl. B32B 37/06

(52) U.S. Cl. 156/273.9

(57) ABSTRACT

A method of fusing thermoplastics components (12, 14) together comprises positioning an electrically conductive member (20) between opposing surfaces (16, 18) of two thermoplastic components to be fused together. The electrically conductive member comprises one or more perforations or spaces between solid material of the member. An electric current is caused to flow in the member so as to heat the member and melt at least some plastics material adjacent the opposing surfaces. The melted plastics material penetrates the perforations or spaces in the electrically conductive member, whereby melted plastics material from each component mixes so as to fuse the components.

This invention relates to thermoplastic products and to methods of fusing thermoplastic components together.

Thermoplastic products can be formed by fusing or welding together two or more thermoplastic components. The methods of achieving this involve heating the surfaces of the components that are to be fused, and contacting the heated surfaces so that fusion occurs. A variety of methods may be used to heat the surfaces, including ultrasonics, hot plates and electromagnetic high frequencies.

The difficulties with these known methods are that the surfaces have to be heated before they are brought together, which means that the components have to be manipulated during the fusing operation. Alternatively, if the surfaces are brought together before being heated, then it is difficult to control the penetration of heat to ensure uniform heating and fusion of the components.

The present invention has been conceived with the foregoing in mind.

According to a first aspect of the present invention there is provided a method of fusing thermoplastics components together comprising: positioning an electrically conductive member between opposing surfaces of two thermoplastic components to be fused together, wherein the electrically conductive member comprises one or more spaces between solid material of the member; causing an electric current to flow in the member so as to heat the member and melt at least some plastics material adjacent the opposing surfaces; and causing melted plastics material to penetrate the spaces in the electrically conductive member, whereby melted plastics material from each component mixes so as to fuse the components.

In a preferred embodiment, the spaces comprise perforations in the electrically conductive member.

It is an advantage that the components can be held together with the opposing surfaces in contact with the conductive member before a current is applied to heat the surfaces and fuse the components. No manipulation of heated components is required. It is a further advantage that the melted plastics material penetrates the spaces or perforations in the conductive member, giving rise to an intimate matrix of conductor and thermoplastic material.

In a preferred embodiment, the electric current is a high frequency alternating current. The high frequency alternating current may be induced in the perforated member.

Embodiments of the invention may include the step of applying pressure between the thermoplastics components.

According to a second aspect of the present invention there is provided a method of fusing thermoplastics components together comprising: positioning a perforated electrically conductive member on a first surface of a first thermoplastic component; positioning a second thermoplastic component such that a second surface of the second thermoplastic component is in contact with the perforated electrically conductive member so as to trap the member between the first and second surfaces; causing an electric current to flow in the member so as to heat the member and melt at least some plastics material adjacent the first and second surfaces; and applying a force urging the first and second thermoplastic components together so that melted plastics material penetrates the perforated electrically conductive member and fuses the components together with the perforated member trapped therebetween.

According to a third aspect of the present invention, there is provided a thermoplastic product comprising first and second portions of a thermoplastic material, and a fused interface between said first and second portions, said fused interface comprising an electrically conductive member having one or more spaces between solid material of the member, the spaces being penetrated by said thermoplastic material.

In embodiments of the electrically conductive member comprises perforations distributed across the member. The electrically conductive member may comprise a mesh. The perforations may be round or diamond shaped, or hexagonal.

The invention will now be described by way of an example with reference to the accompanying drawings, in which:

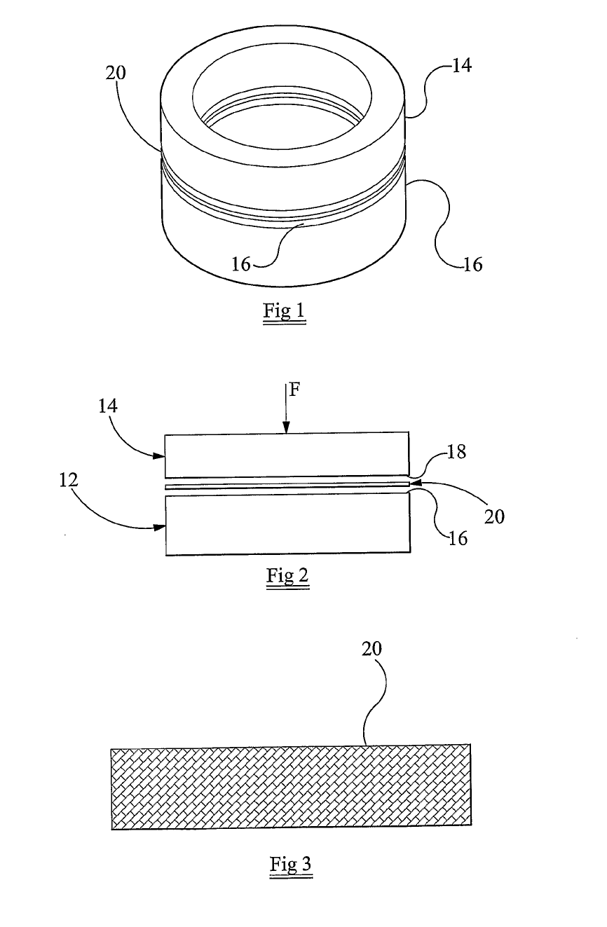

FIG. 1 is a three-dimensional perspective view of an assembly of components for forming a thermoplastic product;

FIG. 2 is a side elevation of the assembly of FIG. 1; and

FIG. 3 illustrates a perforated mesh material for use in the assembly of FIG. 1.

Referring to FIGS. 1 and 2, a product 10 is to be formed from a first thermoplastic component 12 and a second thermoplastic component 14. The first and second thermoplastic components 12, 14 are shown as annular-shaped components, but this is illustrative only. The components could be of any appropriate shape. The first thermoplastic component 12 has an upper surface 16, while the second thermoplastic component 14 has a lower surface 18 (not visible in FIG. 1). The first and second thermoplastic components 12, 14 are to be joined by being fused together at the upper surface 16 of the first component 12 and lower surface 18 of the second component 14.

A perforated member 20, of a conductive material is positioned on top of the first surface 16. Examples of suitable materials for the perforated conductive member 20 are described below. The second component 14 is then positioned on top of the first component 12, so that the perforated conductive member 20 is trapped underneath the second surface 18.

A current is passed through the perforated member 20. The current could be applied by simply connecting electrodes to the member 20 at suitable locations. However, it is preferred to pass a high frequency alternating current through the perforated member 20, and this may be achieved by inducing such a current in the member using a suitably located induction coil. The frequency used is typically in the range 150-400 kHz.

Whichever method is used, the current in the perforated member 20 causes it to heat up due to resistive heating. The heat causes the thermoplastic material of the components 12, 14 to heat up at the contacting upper and lower surfaces 16, 18. The current is applied at a level, and for sufficient time for the thermoplastic materials adjacent the upper and lower surfaces 16, 18 to melt. The molten material then flows into the perforations in the perforated conductive member 20. When the molten material from each of the thermoplastic components 12, 14 meets it will mix together, so that the spaces in the perforations fill with molten plastics material.

The molten material may be permitted simply to flow under gravity and/or due to capillary action into the perforations. However, in many circumstances it is desirable to apply a force (in the direction of the arrow F, in FIG. 2) so that the first and second thermoplastic components are squeezed together. The application of force F creates a pressure in the molten plastics material which urges it into the perforations and ensures a thorough mixing and fusion of the components.

When the current is removed, the components will start to cool. The molten plastics will solidify, forming a single, fused product. The perforated conductive member 20 remains fused in position at the fused interface of the two components.

FIG. 3 illustrates an example of a perforated member 20, in the form of a metallic mesh material. This could be a wire mesh or an expanded metal (expamet) mesh, in which the perforations are distributed, more or less uniformly, across the material. Alternatively, the perforated member could be a sheet material with holes punched or drilled.

The perforations may be of any shape or size. Examples include round holes, diamond-shaped perforations, and hexagonal perforations. The perforations may be of a uniform size across the member 20. Alternatively the sizes may vary, especially if it is desired to provide a profile of varying heating and melting of the plastics.

It will be appreciated that the perforated member may take a wide variety of forms. What is important is that there are spaces between the solid material of the conducting member so that passing of a current in the member generates the heat required to melt the plastics, which can then flow into the spaces.

1-4. (canceled)

5. A method of fusing thermoplastics components together comprising:
positioning an electrically conductive member on a first surface of a first thermoplastic component, the electrically conductive member comprising one or more perforations forming spaces between solid material of the electrically conductive member;
positioning a second thermoplastic component such that a second surface of the second thermoplastic component is in contact with the electrically conductive member so as to trap the electrically conductive member between the first and second surfaces;
inducing a high frequency alternating electric current to flow in the electrically conductive member so as to heat the electrically conductive member and melt at least some plastics material adjacent the first and second surfaces; and
applying a force urging the first and second thermoplastic components together so as to create a pressure in the molten plastics material, which urges the molten material into the perforations of the electrically conductive member and fuses the first and second thermoplastic components together with the electrically conductive member trapped therebetween.

6. A thermoplastic product comprising
first and second portions of a thermoplastic material, and a fused interface between said first and second portions, said fused interface comprising an electrically conductive member comprising perforations forming spaces between solid material of the electrically conductive member, the spaces being penetrated by said thermoplastic material, and wherein the perforations are distributed across the electrically conductive member, the perforations having sizes that vary across the electrically conductive member to provide a predetermined profile of heating and melting of the plastics when a high frequency alternating current is induced in the electrically conductive member.

7-8. (canceled)

9. A thermoplastic product according to claim 6 wherein the perforations are round.

10. A thermoplastic product according to claim 6 wherein the perforations are diamond shaped.

11. A thermoplastic product according to claim 6 wherein the perforations are hexagonal.

12. A method according to claim 5, wherein the electrically conductive member comprises a mesh.

13. A method according to claim 5, wherein the electrically conductive member comprises perforations distributed across the electrically conductive member.

14. A method according to claim 13, wherein the perforations have sizes that vary across the electrically conductive member to provide a predetermined profile of heating and melting of the plastics.

15. A method according to claim 5, wherein the perforations are round.

16. A method according to claim 5, wherein the perforations are diamond-shaped.

17. A method according to claim 5, wherein the perforations are hexagonal.
